(19) United States
(12) Patent Application Publication
(10) Pub. No.: US 2026/0116093 A1
(43) Pub. Date: Apr. 30, 2026

(54) DRYING DEVICE AND IMAGE FORMING APPARATUS

(71) Applicant: KYOCERA Document Solutions Inc., Osaka (JP)

(72) Inventor: Junichi Fukuoka, Osaka (JP)

(21) Appl. No.: 19/365,045

(22) Filed: Oct. 21, 2025

(30) Foreign Application Priority Data
Oct. 31, 2024 (JP) 2024-191509

(51) Int. Cl. B41J 11/00; B41J 29/13; B41J 29/377; B41J 29/393

(52) U.S. Cl. CPC B41J 11/00242; B41J 29/13; B41J 29/377; B41J 29/393

(57) ABSTRACT

A drying device according to the present disclosure includes: a lock control portion which performs control of driving an actuator based on a temperature anomaly signal from a temperature detection portion, to lock a cover member at a closing position; a first protection circuit which outputs, when the temperature anomaly signal is input, a drive signal for locking the cover member at the closing position; a heating control portion which performs control of stopping a heating portion based on a cover open signal from a cover detection portion during heating by the heating portion; and a second protection circuit which outputs, when the cover open signal is input, a stop signal for stopping the heating portion.

### INCORPORATION BY REFERENCE

This application is based upon and claims the benefit of priority from the corresponding Japanese Patent Application No. 2024-191509 filed on Oct. 31, 2024, the entire contents of which are incorporated herein by reference.

### BACKGROUND

The present disclosure relates to a drying device which heats and dries a recording medium on which an image has been formed, and an image forming apparatus including this drying device.

From the past, there has been known an inkjet-recording-type image forming apparatus including a sheet drying device that heats and dries a sheet on which an image has been formed using a heating portion such as a heater. The sheet drying device applies heat to the sheet being conveyed by a conveying belt to dry ink on the sheet being conveyed, for example.

As this type of sheet drying device, there is proposed a drying device which is configured to lock, when a temperature inside a housing exceeds a predetermined first temperature, an outer cover provided in the housing so that the outer cover becomes unopenable, and to unlock, when a temperature equal to or lower than the first temperature is detected, the outer cover so that the outer cover becomes openable.

### SUMMARY

A drying device according to an aspect of the present disclosure includes: a heating portion which is provided inside a housing and heats a recording medium on which an image has been formed; a temperature detection portion which outputs a temperature anomaly signal when a temperature inside the housing becomes equal to or higher than a predetermined setting temperature; a cover member provided in the housing while being openable and closable; a lock mechanism including an actuator which locks the cover member at a closing position; a cover detection portion which detects an opened state of the cover member and outputs a cover open signal indicating the opened state; a lock control portion which performs control of driving the actuator based on the temperature anomaly signal from the temperature detection portion, to lock the cover member at the closing position; a first protection circuit which outputs, when the temperature anomaly signal is input, a drive signal for locking the cover member at the closing position; a heating control portion which performs control of stopping the heating portion based on the cover open signal from the cover detection portion during heating by the heating portion; and a second protection circuit which outputs, when the cover open signal is input, a stop signal for stopping the heating portion.

An image forming apparatus according to another aspect of the present disclosure includes: an image forming portion which forms an image on a recording medium; and the drying device which dries the recording medium on which the image has been formed by the image forming portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an inkjet recording apparatus according to an embodiment of the present disclosure;

FIG. 2 is a block diagram showing a configuration of a control portion of the inkjet recording apparatus according to the embodiment of the present disclosure;

FIG. 3 is a circuit diagram showing configurations of a lock control circuit and a heater control circuit according to the embodiment of the present disclosure;

FIG. 4 are timing charts related to cover lock operation control in a case where an anomalous temperature is detected during heating in the embodiment of the present disclosure;

FIG. 5 are timing charts related to heater operation control in a case where a cover is opened during normal heating in the embodiment of the present disclosure;

FIG. 6 are timing charts related to the heater operation control in a case where an anomalous temperature is detected during heating in the embodiment of the present disclosure;

FIG. 7 is a flowchart showing exemplary procedures of safety processing executed by the control portion; and

FIG. 8 is a flowchart showing exemplary procedures of the safety processing executed by the control portion.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

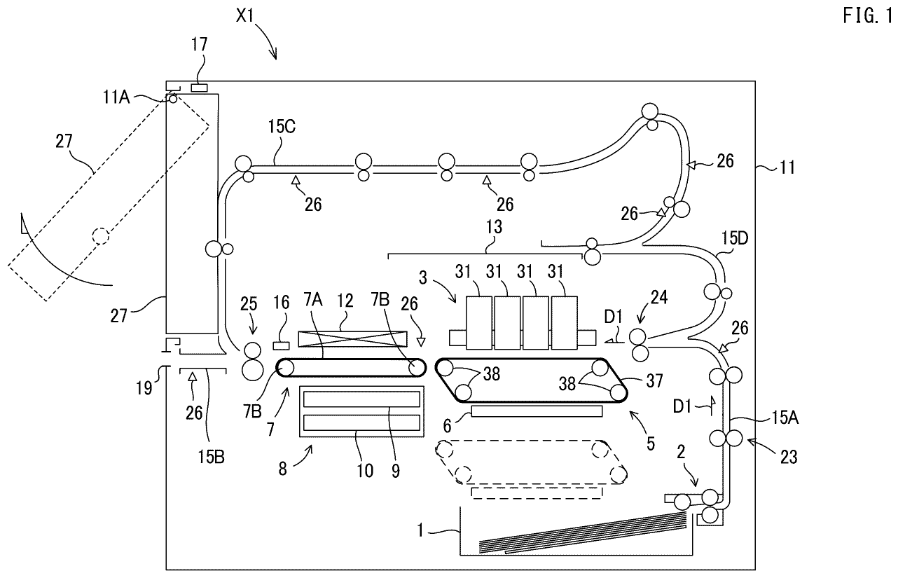

First, an inkjet recording apparatus X1 (hereinafter, will be abbreviated as “recording apparatus X1”) according to the embodiment of the present disclosure will be described with reference to FIG. 1. FIG. 1 is a diagram showing a configuration of the recording apparatus X1. FIG. 1 shows a state where a first conveying unit 5 of the recording apparatus X1 is arranged at a recording position where printing by a recording portion 3 can be performed. Also in FIG. 1, the first conveying unit 5 in a case where the first conveying unit 5 is arranged at an evacuation position that is a predetermined distance below the recording position is indicated by a dashed line.

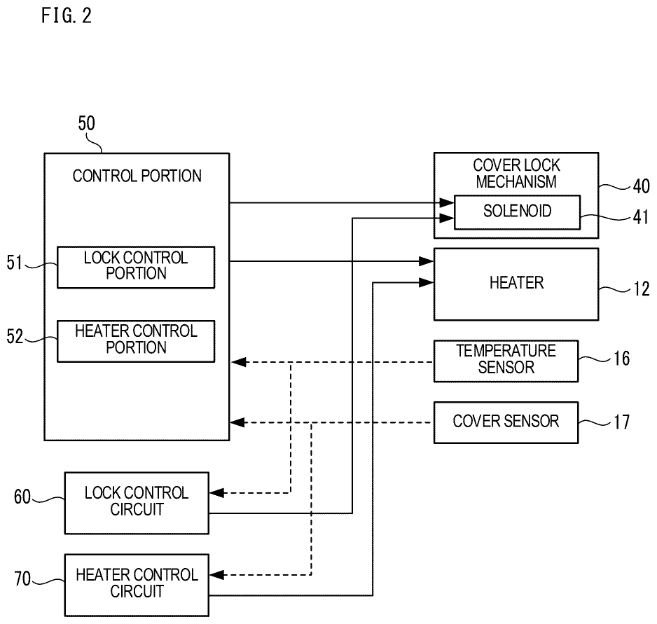

The recording apparatus X1 is an example of an image recording apparatus according to the present disclosure, and records an ink image on a sheet such as printing paper (an example of a recording medium according to the present disclosure) based on an inkjet recording method. As shown in FIG. 1, the recording apparatus X1 includes a sheet feed cassette 1, a sheet feed portion 2, a recording portion 3 (an example of an image forming portion according to the present disclosure), a first conveying unit 5, a lifting mechanism 6, a second conveying unit 7, a heater 12 (an example of a heating portion according to the present disclosure), a maintenance unit 8, a temperature sensor 16 (an example of a temperature detection portion according to the present disclosure), a cover sensor 17 (an example of a cover detection portion according to the present disclosure), an outer cover 27 (an example of a cover member according to the present disclosure), a cover lock mechanism 40 (an example of a lock mechanism according to the present disclosure; see FIG. 2), a control portion 50 (see FIG. 2), a lock control circuit 60 (an example of a first protection circuit according to the present disclosure), a heater control circuit 70 (an example of a second protection circuit according to the present disclosure), a housing 11 that houses or supports these components, and the like.

The second conveying unit 7, the heater 12, the control portion 50, the lock control circuit 60, and the heater control circuit 70 realize a drying device according to the present disclosure.

Four conveying paths 15 (15A, 15B, 15C, and 15D) are provided inside the housing 11. The first conveying path 15A guides a sheet from the sheet feed cassette 1 to the recording portion 3. The second conveying path 15B guides a sheet from the second conveying unit 7 to a discharge port 19. The third conveying path 15C guides a sheet from the second conveying unit 7 to an intermediate tray 13 for switchback, and is also called a switchback conveying path in general. The fourth conveying path 15D guides a sheet on which an image has been recorded from the intermediate tray 13 to the recording portion 3.

Further, the conveying path 15 is provided with a plurality of sheet detection sensors 26 that detect a presence or absence of a sheet and/or a position of a sheet, and detect a tip end or rear end of a sheet.

The recording apparatus X1 is a printer that executes print processing based on input image data. It is noted that an image forming apparatus according to the present disclosure is not limited to the printer that records an image on a sheet such as printing paper, and may be an apparatus that records an image on a flat surface of an OHP sheet, cloth, clothing, or the like, for example.

The sheet feed portion 2 takes out sheets one by one from the sheet feed cassette 1, and feeds the sheets to the first conveying path 15A. The sheet fed to the first conveying path 15A is conveyed to a registration roller pair 24 by a conveying roller pair 23.

The registration roller pair 24 is provided right before the recording portion 3. The registration roller pair 24 includes a drive roller and a driven roller that are in pressure contact with each other, and conveys the sheet to the recording portion 3 at a predetermined conveying timing (image writing start timing).

The first conveying unit 5 and the recording portion 3 are arranged on a downstream side of the registration roller pair 24 in a conveying direction D1.

The recording portion 3 includes four line heads 31 (an example of a recording head) corresponding to respective colors black, cyan, magenta, and yellow. The line heads 31 are supplied with ink from ink tanks (not shown) through ink tubes. It is noted that the number of line heads 31 is not limited to four described above, and only needs to be at least one. The line head 31 includes a plurality of ink nozzles capable of ejecting ink across an entire sheet width. Therefore, the line head 31 can record an ink image on the sheet without scanning in the width direction.

The recording portion 3 forms an ink image on the sheet conveyed by the first conveying unit 5. The recording portion 3 records an ink image on the sheet by causing ink to be ejected from the ink nozzles of each of the line heads 31. As an ink ejection method for the line head 31, for example, a piezo method in which ink is ejected using a piezo element, a thermal method in which ink is ejected by generating bubbles by heating, or the like, is adopted.

The first conveying unit 5 is arranged below the recording portion 3. The first conveying unit 5 conveys the sheet in the conveying direction D1 while causing the sheet to oppose an ink ejection surface of each of the line heads 31. Specifically, the first conveying unit 5 includes a paper conveying belt 37 on which a sheet is placed, a plurality of tension rollers 38 across which the paper conveying belt 37 is stretched, a unit frame (not shown) that supports these, and the like. When the tension rollers 38 are driven rotationally, the paper conveying belt 37 rotates to thus enable the first conveying unit 5 to convey the sheet in the conveying direction D1.

The lifting mechanism 6 lifts and lowers the first conveying unit 5 in an up-down direction with respect to the line heads 31.

When printing is not performed, the maintenance unit 8 is arranged at a predetermined standby position (a position shown in FIG. 1) on the downstream side of the recording portion 3 in the conveying direction D1. The maintenance unit 8 is a mechanism for maintaining or recovering ejection performance of the line heads 31, and includes a cap unit 9, a wipe unit 10, and the like.

The second conveying unit 7 is provided on the downstream side of the recording portion 3 in the conveying direction D1. The second conveying unit 7 conveys a sheet having an ink image recorded on an upper surface thereof by the recording portion 3 in the conveying direction D1. The second conveying unit 7 includes a conveying belt 7A on which a sheet is placed, a pair of tension rollers 7B across which the conveying belt 7A is stretched, a frame that supports these, and the like. The sheet having the ink image recorded on the upper surface thereof by the recording portion 3 is conveyed in the conveying direction D1 by the second conveying unit 7 while being retained on an upper surface of the conveying belt 7A.

The heater 12 for drying is provided above the second conveying unit 7. The heater 12 heats the recording surface of the sheet on which the ink image has been formed, to dry the ink on the sheet. Specifically, the heater 12 is a heating device that supplies heat toward the image recording surface (upper surface) of the sheet on the conveying belt 7A and heats the sheet to dry the ink image on the sheet. The heater 12 is, for example, an infrared heater that radiates infrared rays according to power feeding or a halogen heater. It is noted that the heating device used for the heater 12 is not limited.

When the sheet to be heated is conveyed to the conveying belt 7A of the second conveying unit 7, the control portion 50 starts heating by driving the heater 12. Then, when the sheet is discharged from the conveying belt 7A in the conveying direction D1, the control portion 50 stops driving the heater 12.

The temperature sensor 16 for detecting a temperature inside the housing 11 is provided inside the housing 11. The temperature sensor 16 is used to detect anomalous heating during heating by the heater 12. In the present embodiment, the temperature sensor 16 is provided near the heater 12, more specifically, is arranged above a rear end portion of the conveying belt 7A in the conveying direction D1.

The temperature sensor 16 outputs a temperature anomaly signal when the temperature inside the housing 11 becomes equal to or higher than a predetermined setting temperature. The setting temperature is set to a temperature at which an anomalous heating state (anomalous temperature) due to heating by the heater 12 can be determined. For example, a thermistor such as an NTC thermistor or a CTR thermistor whose resistance value decreases when the temperature exceeds the setting temperature can be applied as the temperature sensor 16. It is noted that for example, a temperature sensor having a contact point that is turned off when the temperature exceeds the setting temperature can also be applied as the temperature sensor 16.

The sheet that has passed through the heater 12 is conveyed to either the second conveying path 15B or the third conveying path 15C by the conveying roller pair 25. For example, when the sheet is to be discharged from the discharge port 19, the sheet is conveyed to the second conveying path 15B. On the other hand, when printing is to be also performed on the opposite side of the sheet, the sheet is conveyed to the third conveying path 15C.

A flap (not shown) for changing the sheet conveying direction is provided at a branch point between the second conveying path 15B and the third conveying path 15C. The sheet conveying direction is changed by this flap being displaced upon receiving a driving force of a solenoid or a motor.

The outer cover 27 is provided on one side surface of the housing 11 while being openable and closable. The outer cover 27 is a cover member for opening a vertical conveying path that is a part of the third conveying path 15C and extends in the vertical direction. An upper end of the outer cover 27 is rotatably supported by a support shaft 11A provided in the housing 11. The outer cover 27 is rotatable between a closed attitude for forming the vertical conveying path and an opened attitude for opening the vertical conveying path. The closed attitude is an attitude at a closing position indicated by a solid line in FIG. 1. The opened attitude is an attitude in a case where the outer cover 27 is rotated from the closed attitude to an opening position indicated by a dotted line in FIG. 1.

The cover sensor 17 is provided near the outer cover 27. The cover sensor 17 is a sensor for detecting a rotation state of the outer cover 27. The cover sensor 17 can be constituted of, for example, a transmissive photointerrupter and a shield portion provided in the outer cover 27. Alternatively, a reflective photointerrupter may be applied as the cover sensor 17. When the outer cover 27 is in the closed attitude, the cover sensor 17 outputs a cover close signal which is a voltage signal of a LOW level indicating that the outer cover 27 is in a closed state. Further, when the outer cover 27 is rotated outwardly from the closed attitude to be opened, the cover sensor 17 outputs a cover open signal which is a voltage signal of a HIGH level indicating that the outer cover 27 is in an opened state.

It is noted that although a configuration in which one outer cover 27 is provided in the housing 11 is exemplified in the present embodiment, it is also possible to provide a plurality of covers in the housing 11. Furthermore, another inner cover may be provided on an inner side of the outer cover 27. In this case, a cover sensor that detects an attitude of the cover is provided for each of the covers.

The cover lock mechanism 40 (see FIG. 2) is provided in the housing 11. The cover lock mechanism 40 locks the outer cover 27 in the closed attitude. The cover lock mechanism 40 includes a lock hole provided in the outer cover 27, a lock member provided in the housing 11, and a solenoid 41 (an example of an actuator according to the present disclosure) that operates the lock member. By the lock member being inserted into the lock hole in a state where the outer cover 27 is in the closed attitude, the outer cover 27 is locked in the closed attitude so as to become incapable of rotating to the opened attitude. By coupling the lock member to a plunger of the solenoid 41 and controlling an operation of the solenoid 41 by the control portion 50, locking or unlocking of the outer cover 27 is controlled.

Next, configurations of the control portion 50, the lock control circuit 60, and the heater control circuit 70 of the recording apparatus X1 will be described with reference to FIG. 2. FIG. 2 is a block diagram showing the configuration of the control portion 50.

The control portion 50 collectively controls the recording apparatus X1 and includes a CPU, a ROM, a RAM, and the like. The control portion 50 is configured as a control board in which the CPU, the ROM, the RAM, and the like are mounted on a substrate, for example. The CPU is a processor that executes various types of arithmetic processing. The ROM is a non-volatile storage device in which information such as control programs for causing the CPU to execute various types of processing is stored in advance. The RAM is a volatile or non-volatile storage device that is used as a temporary storage memory (working area) for the various types of processing to be executed by the CPU. The CPU executes the various control programs stored in advance in the ROM. Thus, the recording apparatus X1 is controlled collectively.

As shown in FIG. 2, the control portion 50 includes various control processing portions such as a lock control portion 51 and a heater control portion 52. Here, the lock control portion 51 is an example of a lock control portion according to the present disclosure. The heater control portion 52 is an example of a heating control portion according to the present disclosure.

The lock control portion 51 drives the solenoid 41 to control locking of the outer cover 27. Specifically, when image forming processing is performed in the recording apparatus X1, the lock control portion 51 locks the outer cover 27 in the closed attitude. Further, when the image forming processing is ended or when a paper jam occurs during the image forming processing, the lock control portion 51 unlocks the outer cover 27 so as to enable the outer cover 27 to rotate to the opened attitude. It is noted that it is not always necessary to lock the outer cover 27 during the image forming processing.

Furthermore, the lock control portion 51 performs control of driving the solenoid 41 based on the temperature anomaly signal from the temperature sensor 16 to lock the outer cover 27 in the closed attitude. When the temperature anomaly signal is received during heating by the heater 12, the lock control portion 51 locks the outer cover 27 in the closed attitude for safety so as to prevent the outer cover 27 from being opened easily. Then, when the temperature anomaly signal is stopped, the lock control portion 51 unlocks the outer cover 27.

The heater control portion 52 controls the heating by the heater 12. When a sheet to be heated is conveyed to the conveying belt 7A, the heater control portion 52 drives the heater 12 to start heating. Then, when the sheet is discharged from the conveying belt 7A in the conveying direction D1, the heater control portion 52 stops driving the heater 12. It is noted that when a plurality of sheets are conveyed continuously, the drying operation by the heating of the heater 12 continues until the last sheet is discharged. It is noted that a sheet conveying position can be determined based on a detection signal obtained by a sheet detection sensor 26 provided on a front side of the conveying belt 7A.

Further, during the heating by the heater 12, the heater control portion 52 performs control of stopping the heating of the heater 12 based on the cover open signal from the cover sensor 17. Specifically, when the cover open signal is received during the heating by the heater 12, the heater control portion 52 stops the heating by the heater 12 for safety so as to protect a user from a burn due to heat, and the like.

As will be described later, the lock control circuit 60 is an electric circuit constituted of electronic components and the like. The lock control circuit 60 can be constituted of an integrated circuit such as an ASIC or an LSI. When the temperature anomaly signal is input from the temperature sensor 16, the lock control circuit 60 outputs a voltage signal (drive signal) for locking the outer cover 27 in the closed attitude. The lock control circuit 60 will be described in detail later.

As will be described later, the heater control circuit 70 is an electric circuit constituted of electronic components and the like. The heater control circuit 70 can be constituted of an integrated circuit such as an ASIC or an LSI. When the cover open signal is input, the heater control circuit 70 outputs a voltage signal (stop signal) for stopping the heater 12. The heater control circuit 70 will be described in detail later.

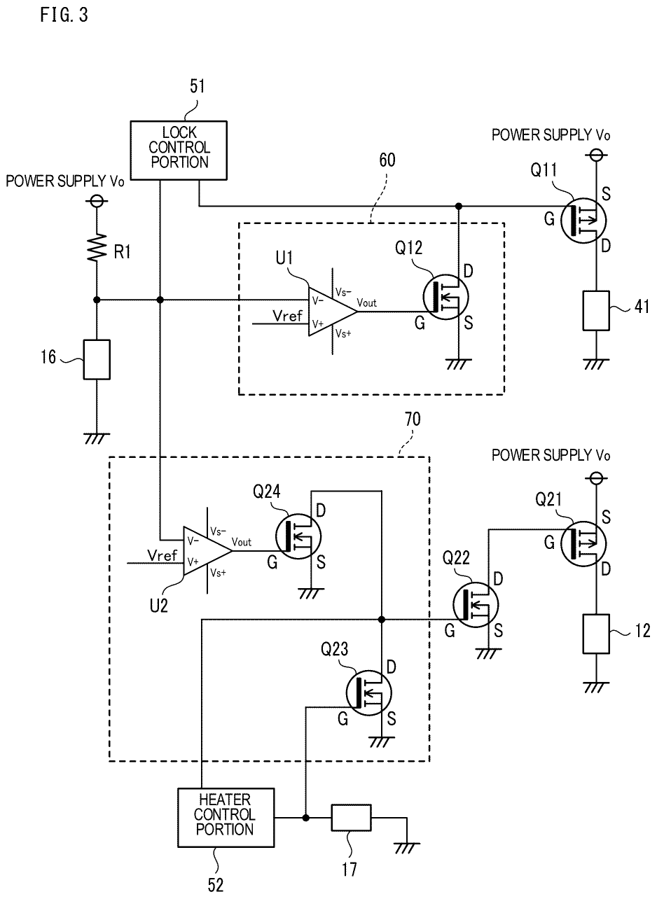

FIG. 3 is a circuit diagram showing the configurations of the lock control circuit 60 and the heater control circuit 70.

As shown in FIG. 3, a switching element Q11 of a P channel type (an example of a first switching portion according to the present disclosure) is provided on a voltage supply line between a power supply Vo and the solenoid 41. The switching element Q11 is, for example, a MOSFET of the P channel type. The switching element Q11 is mounted on, for example, the control board constituting the control portion 50. A source terminal of the switching element Q11 is connected to the power supply Vo, and a drain terminal of the switching element Q11 is connected to an input terminal of the solenoid 41.

The lock control circuit 60 includes a switching element Q12 of an N channel type (an example of a second switching portion according to the present disclosure) and a comparator U1 (an example of a first comparator according to the present disclosure).

The switching element Q12 is, for example, a MOSFET of the N channel type. A drain terminal of the switching element Q12 is connected to a gate terminal of the switching element Q11, and a source terminal of the switching element Q12 is connected to a ground potential.

The comparator U1 includes an input terminal (non-inverting input terminal) V+, an input terminal (inverting input terminal) V−, a positive power supply terminal Vs+, a negative power supply terminal Vs−, and an output terminal Vout. The comparator U1 compares voltages respectively input to the input terminals, and outputs, when the input voltage of the input terminal V− is smaller than the input voltage of the input terminal V+ (reference voltage Vref), a first output voltage of a predetermined voltage (a voltage of a HIGH level) from the output terminal Vout to a gate terminal of the switching element Q12. Thus, the switching element Q12 is set to an on state, and the drain terminal and the source terminal are electrically connected so that a current flows from the drain terminal to the source terminal. On the other hand, when the input voltage of the input terminal V− is larger than the input voltage of the input terminal V+ (reference voltage Vref), the comparator U1 outputs a voltage of a LOW level from the output terminal Vout to the gate terminal of the switching element Q12. In this case, the switching element Q12 maintains an off state.

In the present embodiment, a predetermined reference voltage Vref is input to the input terminal V+ of the comparator U1.

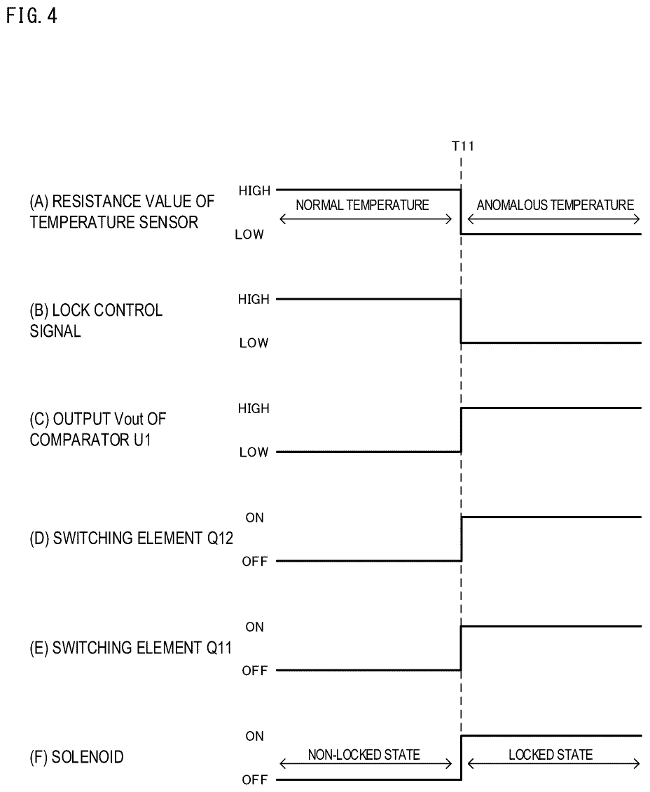

When the temperature sensor 16 detects a temperature equal to or higher than the setting temperature (anomalous temperature), a resistance value of the temperature sensor 16 decreases (see FIG. 4A). In FIGS. 4, a time point T11 is a timing at which the temperature sensor 16 has detected an anomalous temperature equal to or higher than the setting temperature. In this case, a first input voltage obtained by dividing a power supply voltage of the power supply Vo by a resistor R1 is input to the input terminal V− of the comparator U1. This first input voltage is a voltage smaller than the reference voltage Vref. In other words, when the temperature inside the housing 11 becomes equal to or higher than the setting temperature, the temperature sensor 16 inputs the first input voltage to the input terminal V− of the comparator U1 as the temperature anomaly signal. Thus, the first output voltage of a HIGH level, that is of a predetermined voltage, is output from the output terminal Vout of the comparator U1 to the gate terminal of the switching element Q12 (see FIG. 4C).

When the first output voltage is input to the gate terminal of the switching element Q12, the switching element Q12 is set to the on state (see FIG. 4D). Thus, the drain terminal and the source terminal are electrically connected, and a current flows from the drain terminal to the source terminal. This also brings the gate terminal of the switching element Q11 to the ground potential, so the switching element Q11 is set to the on state (see FIG. 4E), and the source terminal and the drain terminal of the switching element Q11 are electrically connected so that a current flows from the source terminal to the drain terminal. Thus, the power supply voltage of the power supply Vo is supplied to the solenoid 41 so that the solenoid 41 is operated to lock the outer cover 27 in the closed attitude (see FIG. 4F).

It is noted that when the temperature sensor 16 detects a temperature lower than the setting temperature, a voltage larger than the reference voltage Vref is input to the input terminal V− of the comparator U1. Therefore, in this case, a voltage of a LOW level is output from the output terminal Vout of the comparator U1 to the gate terminal of the switching element Q12.

Further, the first input voltage is also input to the lock control portion 51. That is, when the temperature inside the housing 11 becomes equal to or higher than the setting temperature, the temperature sensor 16 inputs the first input voltage to the lock control portion 51 as the temperature anomaly signal. It is noted that when the temperature sensor 16 detects a temperature lower than the setting temperature, a voltage larger than the reference voltage Vref is input to the lock control portion 51 as a normal signal (non-anomalous signal).

When the first input voltage is input, the lock control portion 51 outputs a voltage signal comparable with the ground potential to the gate terminal of the switching element Q11 as a lock drive signal, for operating the switching element Q11 (see FIG. 4B). Thus, the switching element Q11 is set to the on state (see FIG. 4E), and the source terminal and drain terminal of the switching element Q11 are electrically connected so that a current flows from the source terminal to the drain terminal. As a result, the power supply voltage of the power supply Vo is supplied to the solenoid 41 so that the solenoid 41 is operated to lock the outer cover 27 in the closed attitude.

As shown in FIG. 3, a switching element Q21 of a P channel type (an example of a third switching portion according to the present disclosure) is provided on a voltage supply line between the power supply Vo and the heater 12. The switching element Q21 is, for example, a MOSFET of the P channel type. The switching element Q21 is mounted on, for example, the control board constituting the control portion 50. The source terminal of the switching element Q21 is connected to the power supply Vo, and the drain terminal of the switching element Q21 is connected to the input terminal of the heater 12.

Further, the control board is provided with a switching element Q22 (an example of a fourth switching portion according to the present disclosure). The switching element Q22 is a switching element of an N channel type and is, for example, a MOSFET of the N channel type. The drain terminal of the switching element Q22 is connected to the gate terminal of the switching element Q21, and a source terminal of the switching element Q22 is connected to the ground potential.

The heater control circuit 70 includes at least a switching element Q23 of an N channel type (an example of a fifth switching portion according to the present disclosure). In addition, the heater control circuit 70 further includes a switching element Q24 of an N channel type (a sixth switching portion) and a comparator U2 (a second comparator).

The switching elements Q23 and Q24 are, for example, MOSFETs of the N channel type.

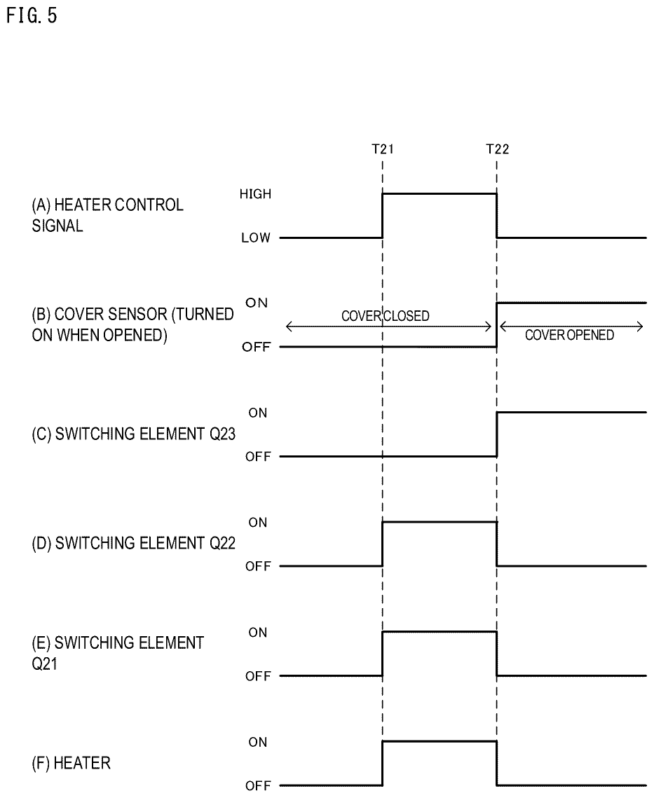

The drain terminal of the switching element Q23 is connected to the gate terminal of the switching element Q22, and the source terminal of the switching element Q23 is connected to the ground potential. Further, an output signal of the cover sensor 17 (the cover open signal or the cover close signal) is input to the gate terminal of the switching element Q23. In other words, when detecting that the outer cover 27 is in the opened attitude, the cover sensor 17 inputs the cover open signal of a HIGH level to the gate terminal of the switching element Q23 as a second input voltage (see FIG. 5B). In FIGS. 5, a time point T22 is a timing at which it is detected that the outer cover 27 has been opened. Thus, the switching element Q23 is set to the on state (see FIG. 5C).

When the switching element Q23 is set to the on state, the gate terminal of the switching element Q22 becomes the ground potential, so the switching element Q22 is set to the off state (see FIG. 5D). Also, since the gate terminal of the switching element Q21 becomes a voltage equal to or larger than the ground potential, the switching element Q21 is set to the off state, and the source terminal and the drain terminal become non-conductive (see FIG. 5E). Thus, the power supply voltage of the power supply Vo is no longer supplied to the heater 12, and the operation of the heater 12 stops (see FIG. 5F).

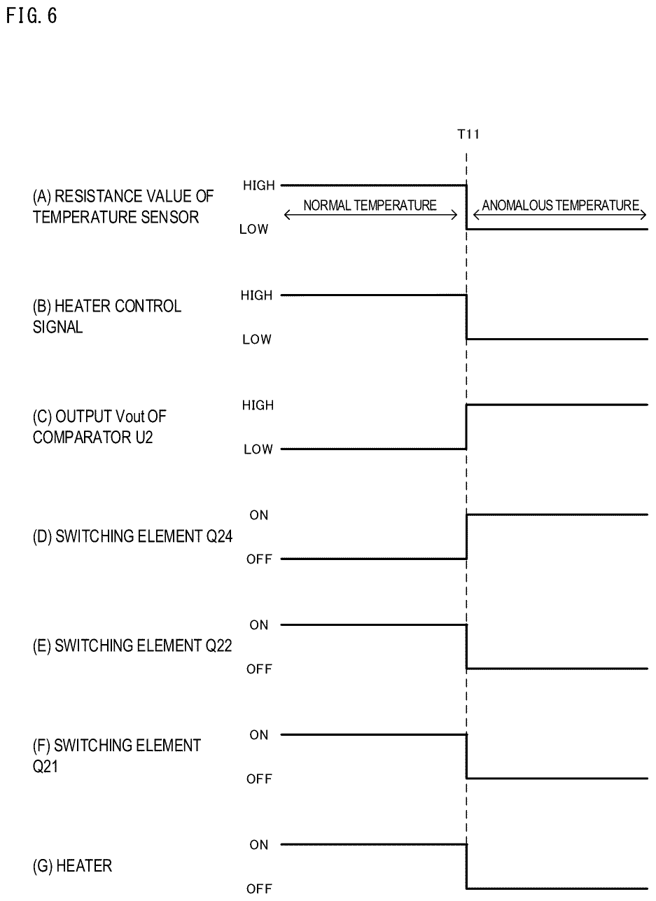

It is noted that when the cover sensor 17 detects that the outer cover 27 is in the closed attitude, the cover close signal of a LOW level is input to the gate terminal of the switching element Q23 (see FIG. 5B). In this case, the switching element Q23 maintains the off state (see FIG. 5C). On the other hand, when the temperature sensor 16 detects a normal temperature, a voltage signal of a LOW level, that indicates the normal temperature is input from the output terminal Vout of the comparator U2 to the gate terminal of the switching element Q24 as will be described later (see FIG. 6C). In this case, the switching element Q24 maintains the off state (see FIG. 6D). Therefore, the switching element Q22 is set to the on state (see FIG. 6E), and the switching element Q21 is set to the on state (see FIG. 6F). Thus, the supply of the power supply voltage of the power supply Vo to the heater 12 is continued, and the heating control of the heater 12 is continued (see FIG. 6G).

Further, the second input voltage is also input to the heater control portion 52. That is, when detecting that the outer cover 27 is in the opened attitude, the cover sensor 17 inputs the cover open signal of a HIGH level to the heater control portion 52 as the second input voltage. It is noted that when the cover sensor 17 detects that the outer cover 27 is in the closed attitude, the cover close signal of a LOW level is input to the heater control portion 52.

When the cover open signal is input, the heater control portion 52 outputs a voltage signal comparable with the ground potential to the gate terminal of the switching element Q22 as a heater stop signal, for setting the switching element Q22 to the off state (see FIG. 5A). Thus, since the gate terminal of the switching element Q22 becomes the ground potential, the switching element Q22 is set to the off state (see FIG. 5D), and further, the switching element Q21 is set to the off state (see FIG. 5E), and thus the operation of the heater 12 is stopped (see FIG. 5F).

It is noted that when the heater 12 is driven to perform heating, the heater control portion 52 outputs a voltage signal of a HIGH level to the gate terminal of the switching element Q22 as a heater drive signal, for setting the switching element Q22 to the on state (see FIG. 5A). In FIGS. 5, a time point T21 is a timing at which the heater drive signal is output. Thus, unless the switching elements Q23 and Q24 are in the on state, the switching element Q22 is set to the on state (see FIG. 5D), and further, the switching element Q21 is set to the on state (see FIG. 5E), and thus the heater 12 operates to start heating (see FIG. 5F).

The comparator U2 includes an input terminal (non-inverting input terminal) V+, an input terminal (inverting input terminal) V−, a positive power supply terminal Vs+, a negative power supply terminal Vs−, and an output terminal Vout. The comparator U2 compares the voltages respectively input to the input terminals, and outputs, when the input voltage of the input terminal V− is smaller than the input voltage of the input terminal V+, an output voltage of a predetermined voltage from the output terminal Vout to the gate terminal of the switching element Q24. Thus, the switching element Q24 is set to the on state, and the drain terminal and the source terminal are electrically connected so that a current flows from the drain terminal to the source terminal. On the other hand, when the input terminal V− is larger than the input terminal V+, the comparator U2 outputs a voltage of a LOW level from the output terminal Vout to the gate terminal of the switching element Q24. In this case, the switching element Q24 maintains the off state.

In the present embodiment, a predetermined reference voltage Vref is input to the input terminal V+ of the comparator U2.

When the temperature sensor 16 detects a temperature equal to or higher than the setting temperature (anomalous temperature), the first input voltage, which is a voltage obtained by dividing the power supply voltage of the power supply Vo by the resistor R1 and is smaller than the reference voltage Vref, is input to the input terminal V− of the comparator U2. In other words, when the temperature inside the housing 11 becomes equal to or higher than the setting temperature, the temperature sensor 16 inputs the first input voltage to the input terminal V− of the comparator U2 as the temperature anomaly signal. Thus, the output voltage of a HIGH level, that is of a predetermined voltage, is output from the output terminal Vout of the comparator U2 to the gate terminal of the switching element Q24 (see FIG. 6C).

When the output voltage is input to the gate terminal of the switching element Q24, the switching element Q24 is set to the on state (see FIG. 6D), and the drain terminal and the source terminal are electrically connected so that a current flows from the drain terminal to the source terminal. This also brings the gate terminal of the switching element Q22 to the ground potential (see FIG. 6E), so the switching element Q22 is set to the off state, and further, the switching element Q21 is set to the off state (see FIG. 6F). Thus, the operation of the heater 12 stops (see FIG. 6F).

Incidentally, in a conventional configuration, there is a fear that, when the operation of the lock control portion 51 that controls the locking of the outer cover 27 becomes unstable due to an influence of excessive heat from the heating portion such as the heater 12, the outer cover 27 will not be locked to put the user in danger.

In contrast, according to the recording apparatus X1 of the present embodiment, when the inside of the apparatus is excessively heated by the heating portion such as the heater 12, the user can be reliably protected from a danger such as a burn due to heat, and a higher level of safety can thus be realized.

### [Safety Processing]

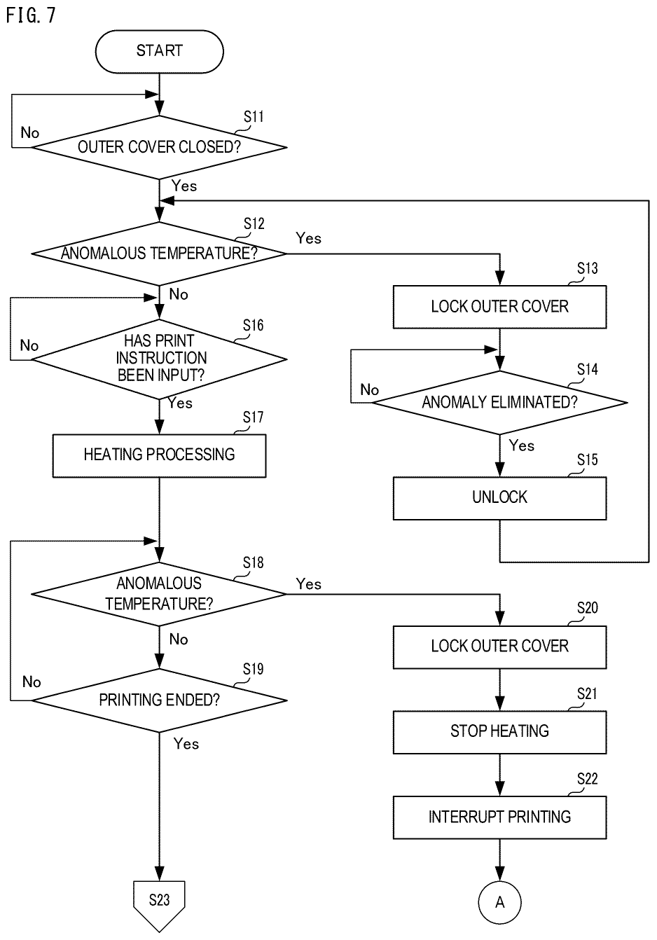

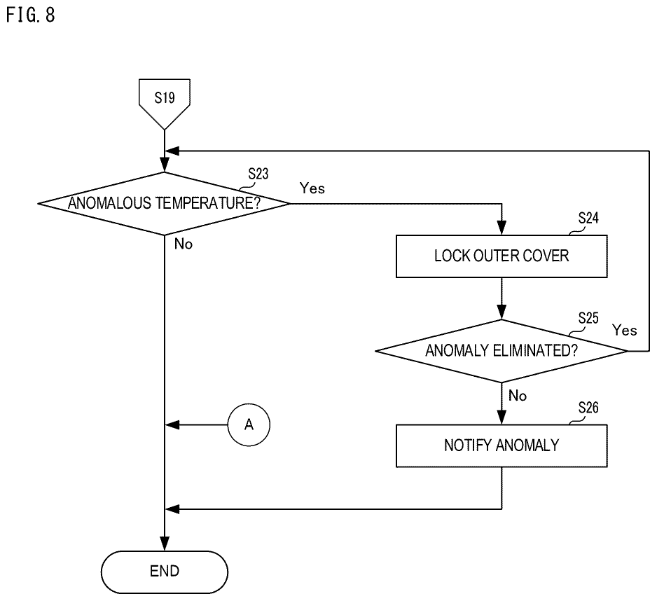

Hereinafter, exemplary procedures of safety processing executed by the recording apparatus X1 will be described with reference to FIG. 7 and FIG. 8. It is noted that the processing of the procedures in the safety processing to be described below includes processing executed by the control portion 50 and processing executed by the lock control circuit 60 or the heater control circuit 70. It is noted that the safety processing shown in FIG. 7 is started in a state where the recording apparatus X1 is waiting for an input of a print instruction (standby state).

As shown in FIG. 7, in Step S11, the control portion 50 determines whether or not the outer cover 27 is closed based on the output signal of the cover sensor 17.

When the outer cover 27 is closed, in next Step S12, the control portion 50 determines whether or not the temperature inside the housing 11 is an anomalous temperature based on the output signal of the temperature sensor 16.

When it is determined as the anomalous temperature in Step S12, the control portion 50 locks the outer cover 27 (S13), and then, after a predetermined time has elapsed, detects the temperature again based on the output signal of the temperature sensor 16 to determine whether or not the anomalous temperature has been eliminated (S14). When the anomalous temperature has been eliminated, the control portion 50 unlocks the outer cover 27 (S15) and performs the processing of Step S12 and subsequent steps.

It is noted that when the temperature sensor 16 detects an anomalous temperature, the first input voltage indicating the anomalous temperature is input to the lock control portion 51 regardless of the processing by the control portion 50, and the lock control portion 51 locks the outer cover 27. Further, when the temperature sensor 16 detects a normal temperature, a voltage signal of a LOW level that indicates the normal temperature is input to the lock control portion 51 regardless of the processing by the control portion 50, and the lock control portion 51 unlocks the outer cover 27.

When it is determined as the normal temperature in Step S12, in next Step S16, the control portion 50 determines whether or not a print instruction has been input. Here, when the print instruction is input, in Step S17, the control portion 50 drives the heater 12 in preparation for drying an ink image recorded on a sheet. Specifically, in order to drive the heater 12, the control portion 50 outputs a voltage signal of a HIGH level to the switching element Q22 as a heater drive signal. Thus, the switching element Q22 is set to the on state (see FIG. 5D), and further, the switching element Q21 is set to the on state (see FIG. 5E), and thus the heater 12 operates to start heating.

After the heating by the heater 12, in Step S18, the control portion 50 determines whether or not the temperature inside the housing 11 has become an anomalous temperature. Here, when it is determined that the temperature inside the housing 11 has become an anomalous temperature, the control portion 50 locks the outer cover 27 (S20), stops driving the heater 12 (S21), and interrupts printing (S22). Thus, the series of processing is ended.

It is noted that when an anomalous temperature is detected by the temperature sensor 16, the first input voltage indicating the anomalous temperature is input to the lock control portion 51 regardless of the processing by the control portion 50, and the lock control portion 51 locks the outer cover 27. In addition, the first input voltage is input to the heater control circuit 70, and the heater control circuit 70 stops driving the heater 12.

On the other hand, when it is not determined as the anomalous temperature in Step S18, the processing of Step S18 and subsequent steps is repeated until the printing ends in next Step S19. Then, when it is determined in Step S19 that the printing has ended, the control portion 50 shifts the process to next Step S23.

As shown in FIG. 8, in next Step S23, the control portion 50 again determines, in a standby state after the end of the print processing, whether or not the temperature inside the housing 11 is an anomalous temperature based on the output signal of the temperature sensor 16. Then, when it is determined as the anomalous temperature in Step S23, the control portion 50 locks the outer cover 27 (S24), and then, after a predetermined time has elapsed, again detects the temperature based on the output signal of the temperature sensor 16 to determine whether or not the anomalous temperature has been eliminated (S25). When the anomalous temperature has been eliminated, the control portion 50 either repeats the processing of Step S23 and subsequent steps or ends the series of processing in the standby state of the recording apparatus X1.

It is noted that when an anomalous temperature is detected by the temperature sensor 16, the first input voltage indicating the anomalous temperature is input to the lock control portion 51 regardless of the processing by the control portion 50, and the lock control portion 51 locks the outer cover 27.

When the anomalous temperature is not eliminated in Step S25, the control portion 50 performs an anomaly notification for displaying an error message indicating a temperature anomaly on a display portion of the recording apparatus X1 (S26). After that, the series of processing is ended.

As described above, the recording apparatus X1 according to the present embodiment is provided with the lock control circuit 60 and the heater control circuit 70 configured as described above, and the control portion 50 is provided with the lock control portion 51 and the heater control portion 52. Therefore, even when the inside of the housing 11 is excessively heated by the heater 12, the user can be reliably protected from a danger such as a burn due to heat, and a higher level of safety can thus be realized.

That is, in the recording apparatus X1 according to the present embodiment, when the temperature sensor 16 detects an anomalous temperature, the outer cover 27 is locked for safety by the lock control portion 51 and the lock control circuit 60. Further, even if the lock control portion 51 does not output the lock drive signal due to a malfunction, the outer cover 27 is locked by the lock control circuit 60. Furthermore, even if a malfunction occurs in the lock control circuit 60, the outer cover 27 is locked by the lock control portion 51.

Furthermore, when the cover sensor 17 detects the opened state of the outer cover 27, the heater 12 is stopped for safety by the heater control portion 52 and the heater control circuit 70. Further, even if the heater control portion 52 does not output the heater stop signal due to a malfunction, the heater 12 is stopped by the heater control circuit 70. Furthermore, even if a malfunction occurs in the heater control circuit 70, the heater 12 is stopped by the heater control portion 52.

### [Notes of Disclosure]

Hereinafter, a general outline of the disclosure extracted from the embodiment described above will be noted. It is noted that the respective configurations and processing functions described in the notes below can be sorted and arbitrarily combined as appropriate.

### <Note 1>

A drying device, including:
a heating portion which is provided inside a housing and heats a recording medium on which an image has been formed;
a temperature detection portion which outputs a temperature anomaly signal when a temperature inside the housing becomes equal to or higher than a predetermined setting temperature;
a cover member provided in the housing while being openable and closable;
a lock mechanism including an actuator which locks the cover member at a closing position;
a cover detection portion which detects an opened state of the cover member and outputs a cover open signal indicating the opened state;
a lock control portion which performs control of driving the actuator based on the temperature anomaly signal from the temperature detection portion, to lock the cover member at the closing position;
a first protection circuit which outputs, when the temperature anomaly signal is input, a drive signal for locking the cover member at the closing position;
a heating control portion which performs control of stopping the heating portion based on the cover open signal from the cover detection portion during heating by the heating portion; and
a second protection circuit which outputs, when the cover open signal is input, a stop signal for stopping the heating portion.

### <Note 2>

The drying device according to note 1, further including:
a first switching portion of a P channel type, which has a source terminal connected to a power supply and a drain terminal connected to a voltage input terminal of the actuator, in which
the first protection circuit includes
a second switching portion of an N channel type, which has a drain terminal connected to a gate terminal of the first switching portion and a source terminal connected to a ground potential, and
a first comparator which outputs, when a first input voltage equal to or larger than a reference voltage is input, a first output voltage of a predetermined voltage to a gate terminal of the second switching portion,
the temperature detection portion inputs, as the temperature anomaly signal, when the temperature inside the housing becomes equal to or higher than the setting temperature, the first input voltage to each of an input terminal of the first comparator and the lock control portion, and
the lock control portion outputs, when the first input voltage is input, a drive signal for operating the first switching portion to the gate terminal of the first switching portion.

### <Note 3>

The drying device according to note 1 or 2, further including:
a third switching portion of a P channel type, which has a source terminal connected to a power supply and a drain terminal connected to a voltage input terminal of the heating portion; and
a fourth switching portion of an N channel type, which has a drain terminal connected to a gate terminal of the third switching portion and a source terminal connected to a ground potential, in which
the second protection circuit includes
a fifth switching portion of an N channel type, which has a drain terminal connected to a gate terminal of the fourth switching portion and a source terminal connected to the ground potential,
the cover detection portion inputs, as the cover open signal, when the opened state of the cover member is detected, a second input voltage of a predetermined voltage to each of a gate terminal of the fifth switching portion and the heating control portion, and
the heating control portion outputs, when the second input voltage is input, a drive signal for operating the fourth switching portion to the gate terminal of the fourth switching portion.

### <Note 4>

An image forming apparatus, including:
an image forming portion which forms an image on a recording medium; and
the drying device according to any one of notes 1 to 3 which dries the recording medium on which the image has been formed by the image forming portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A drying device, comprising:
a heating portion which is provided inside a housing and heats a recording medium on which an image has been formed;
a temperature detection portion which outputs a temperature anomaly signal when a temperature inside the housing becomes equal to or higher than a predetermined setting temperature;
a cover member provided in the housing while being openable and closable;
a lock mechanism including an actuator which locks the cover member at a closing position;
a cover detection portion which detects an opened state of the cover member and outputs a cover open signal indicating the opened state;
a lock control portion which performs control of driving the actuator based on the temperature anomaly signal from the temperature detection portion, to lock the cover member at the closing position;
a first protection circuit which outputs, when the temperature anomaly signal is input, a drive signal for locking the cover member at the closing position;
a heating control portion which performs control of stopping the heating portion based on the cover open signal from the cover detection portion during heating by the heating portion; and
a second protection circuit which outputs, when the cover open signal is input, a stop signal for stopping the heating portion.

2. The drying device according to claim 1, further comprising:
a first switching portion of a P channel type, which has a source terminal connected to a power supply and a drain terminal connected to a voltage input terminal of the actuator, wherein
the first protection circuit includes
a second switching portion of an N channel type, which has a drain terminal connected to a gate terminal of the first switching portion and a source terminal connected to a ground potential, and
a first comparator which outputs, when a first input voltage equal to or larger than a reference voltage is input, a first output voltage of a predetermined voltage to a gate terminal of the second switching portion,
the temperature detection portion inputs, as the temperature anomaly signal, when the temperature inside the housing becomes equal to or higher than the setting temperature, the first input voltage to each of an input terminal of the first comparator and the lock control portion, and
the lock control portion outputs, when the first input voltage is input, a drive signal for operating the first switching portion to the gate terminal of the first switching portion.

3. The drying device according to claim 1, further comprising:
a third switching portion of a P channel type, which has a source terminal connected to a power supply and a drain terminal connected to a voltage input terminal of the heating portion; and
a fourth switching portion of an N channel type, which has a drain terminal connected to a gate terminal of the third switching portion and a source terminal connected to a ground potential, wherein
the second protection circuit includes
a fifth switching portion of an N channel type, which has a drain terminal connected to a gate terminal of the fourth switching portion and a source terminal connected to the ground potential,
the cover detection portion inputs, as the cover open signal, when the opened state of the cover member is detected, a second input voltage of a predetermined voltage to each of a gate terminal of the fifth switching portion and the heating control portion, and
the heating control portion outputs, when the second input voltage is input, a drive signal for operating the fourth switching portion to the gate terminal of the fourth switching portion.

4. An image forming apparatus, comprising:
an image forming portion which forms an image on a recording medium; and
the drying device according to claim 1 which dries the recording medium on which the image has been formed by the image forming portion.
